(19) United States
(12) Patent Application Publication
(10) Pub. No.: US 2002/0046054 A1
(43) Pub. Date: Apr. 18, 2002

(54) Use of blood and plasma donor samples and data in the drug discovery process

(76) Inventors: Patrick G. Morand, Northbrook, IL (US); Marc J. Ostro, Pennington, NJ (US)

Correspondence Address: Finnegan, Henderson, Farabow,, Garrett & Dunner, L.L.P., 1300 I Street, NW, Washington, DC, 20005-3315, US

(21) Appl. No.: 09/938,628

(22) Filed: Aug. 27, 2001

Related U.S. Application Data
(60) Provisional application No. 60/227,910, filed on Aug. 28, 2000.

(51) Int. Cl. G05B 15/00

(52) U.S. Cl. 705/1; 700/1

(57) ABSTRACT

Systems consistent with the present invention provide a method for identifying and recruiting donors whose demographic characteristics, genomic and proteomic profile, and medical histories make them attractive candidates for clinical trials, drug target identification, and pharmacogenomic studies.

This application claims the benefit of U.S. Provisional Application No. 60/227,910, filed Aug. 28, 2000, which is incorporated herein in its entirety for any purpose.

The present invention relates to methods and systems for identifying individuals for clinical trials. More specifically, the present application relates to a method through which the biopharmaceutical industry can gain access to a large and varied population of individuals with a detailed and fully consented medical history as subjects for the clinical trials required for drug development and as sources of research materials. In another aspect, the present invention relates to a method for creating a longitudinal database of biochemical, genomic, and proteomic information as a resource for drug research and development.

### BACKGROUND OF THE INVENTION

Clinical and basic research in the biopharmaceutical industry have the objective of discovery, development, governmental approval, and commercialization of therapies and compounds for diagnosing and treating specific diseases. The phases of discovery, development, approval, and marketing are governed by rigorous laboratory, business, and regulatory standards. The efficient recruitment of patients into studies, however, is often referred to as the Achilles Heel of clinical research.

The multi-billion dollar biopharmaceutical industry continues to struggle to attract the interest of both healthy and diseased individuals to participate in clinical and basic research. Entire companies have been organized to recruit volunteers for studies and to collect biological samples to satisfy research needs. Nevertheless, finding the right individuals either with the targeted disease state or free of the particular disease under study and speeding the process of getting new therapies and medications to market remain serious endeavors. The mechanisms through which study subjects are recruited remain fragmented and uncoordinated.

Clinical trials, which are used to assess the safety and efficacy of potential new diagnostics and therapies, now involve thousands of patients, take years to complete, and cost a great deal. The biopharmaceutical industry spends hundreds of millions of dollars on patient recruitment for its clinical studies. It is a highly regulated, complex, and traditional industry that goes to extreme lengths to find individuals whose medical profiles fit the needs of specific clinical trials. The biopharmaceutical industry prides itself on its success, yet is always seeking new and productive channels of patient recruitment for its research.

A variety of organizations have varying levels of access to samples or medical data from larger populations. These organizations, however, fail to meet the needs of the biopharmaceutical industry.

Clinical Research Organizations (CROs) have access to patient populations with highly detailed medical records and longitudinal data (participants in Phase I trials often repeat). However, these patients lack ethnic diversity and are targeted to very narrowly defined and limited diseases not usually suitable for discovery purposes. To better characterize issues such as unforeseen toxicity events and non-responders, genomics-based investigation will require samples from larger and more diverse populations than those represented solely in current clinical trials.

Diagnostic companies also have wide population access and some of them have growing genotyping capability. However, they have no long-term sample storage infrastructure. Additionally, these companies do not provide medical characterization, medical histories, or interaction with donors. Because of the lack of this interface, diagnostic companies are unable to sample the donors repeatedly or track their disease progression.

Health Maintenance Organizations' (HMOs) primary shortfalls are that current records are claims-based, rather than medical records, and there are no samples associated with these records and no informed consent for the use of these data in research. While claims and pharmaceutical prescription data provide a privileged perspective of each patient, the medical information needed to monitor patient behavior, such as drug compliance or disease progression, resides with the physician, not the insurance provider. HMOs do not maintain a direct patient interface. Additionally, the perception that HMOs could possibly abuse genotyped samples to discriminate against patients creates an environment that is not conducive to the collection of family histories, medical records and longitudinal samples.

Life and disability insurers have single-time point medical data and do not store biological samples. Repeat access to medical data typically occurs only when an individual requests an increase in insurance coverage or makes a claim. Therefore, repeat access over time (i.e., longitudinal access) and access to samples are missing from the insurance companies' capabilities. As is the case with HMOs, consent also is an issue for insurers since genetic disease proclivities might be used to discriminate against patients or alter their insurance rates. The claims data processed by insurance companies for statistical purposes do not include personal identifiers or names which could be used to solicit samples.

Sample collectors and specialty blood banks, such as cord blood banks, have access to high quality samples suitable for genetic analysis. However, the samples are frequently collected outside of the context of diseases and are not connected to extensive medical records other than children's birth records. These are often one time samples with no repeat access or possibility for longitudinal analysis and may not have been collected with full disclosure or consent. Most of such specialty blood banks are local and do not draw from a large population base.

Existing genetic population profiling companies, e.g., deCode genetics and Myriad Genetics, target well-defined, but usually inbred, populations in an effort to discover or validate genetic markers linked to disease. Additionally, the target populations tend to be restricted. For example, deCode genetics has access to the medical and genealogical records of the Icelandic population, albeit with only implied informed consent from the individual subjects. Similarly, Myriad Genetics has access to the genealogical records of Mormons in Utah. Neither company has significant access to subjects outside of the target population to verify that candidate genetic markers are relevant to the general population. An example of the misleading conclusions that can result from the use of these selected population datasets is the initial expectation, based on analysis of selected populations that the BRCA1 mutation was involved in approximately 40% of breast cancers, whereas it is now known that BRCA1 plays a role in only 3%. Furthermore, diseases not prevalent at a high enough frequency in these restricted populations are not addressable.

In contrast, collection establishments enjoy the goodwill and participation of nearly 100,000 individuals each business day. It is well known that blood and plasma donors seek the satisfaction of certain altruistic characteristics through the act of donating. In fact, the safety of a nation's blood supply is typically grounded in the goodwill and honesty of volunteers offering themselves as donors, responding truthfully to medical history questions about their health and certain risk factors in behavior, and the laboratory screening practices for viruses and other diseases known to be transmitted through a transfusion. On average, approximately 15% of those who approach a collection establishment to donate blood are deferred, either temporarily or permanently.

The history of cooperation between the pharmaceutical industry and the blood and plasma industry is well documented, far-reaching, and comprehensive. Without a standing relationship between these industries, blood and plasma organizations would not be able to collect, test, document, and ship products; biopharmaceutical companies would lack significant sales. Professional industry seminars would not be held, nor would numerous physicians, scientists, technologists, and other professionals have access to the latest technology and science in blood and plasma collection and testing. Despite this history of cooperation, however, neither party has developed a method through which the pharmaceutical industry can utilize the sample and data collecting capabilities of the blood and plasma collecting industry to satisfy basic and clinical research needs.

### SUMMARY OF THE INVENTION

Systems and methods consistent with the present invention provide a new function for the process of donor management in regulated blood and plasma organizations, referred to herein as “collection establishments.” To date, the sole purpose of the collection of ancillary blood samples and personal medical information from blood and plasma donors has been to determine the safety of the procedure for both the donor and the eventual recipient. Most individuals who approach a collection establishment are accepted as donors. Some, however, do not meet the standards for acceptance and are deferred from donating, either on a temporary or on a permanent basis.

Using databases and personal donor relationships conventionally directed toward donor and product safety, the instant invention provides a method through which the substantial data and sample collecting capabilities of collection establishments can be used to identify and recruit subjects for participation in clinical trials. Because collection establishments maintain contact with individual donors over an extended period of time, often years or longer, the invention provides methods through which these same capabilities can be used to identify genomic and proteomic factors that are correlated with the development of disease and/or the response of an individual to drug treatment.

The processes contemplated are (1) the referral of select blood and plasma donors into clinical research studies; (2) the recruitment of blood and plasma donors into clinical research studies; (3) the collection of additional samples and data from donors for use in medical research; and (4) the development of a database comprising the bioinformatic analysis of donor medical histories and biological samples, which can be used to identify genomic, proteomic, and pharmacogenomic correlates of disease and therapeutic response.

### BRIEF DESCRIPTION OF THE DRAWINGS

The accompanying drawings, which are incorporated in and constitute a part of this specification, illustrate implementations of the invention and, together with the description, serve to explain the advantages and principles of the invention. In the drawings, dashed lines represent optional elements.

FIG. 1 shows a flowchart of steps involved in processing donors from various sources to generate a clinical trial subject database, a proteomics/genomics/pharmacogenomics database, and a database of biological samples in a manner consistent with the principles of the present invention;

FIG. 2 shows a flowchart for processing an end-user generated query to identify clinical trial subjects in the clinical trial subject database in a manner consistent with the principles of the present invention;

FIG. 3 is a diagram used to explain how repeated samples from individuals are preserved and tested, either prospectively or retrospectively, for genomic abnormalities and proteomic abnormalities. The disease status of the individuals also is monitored;

FIG. 4 shows a system in which methods and systems consistent with the present invention may be implemented; and

FIG. 5 shows the components of a desktop or a server computer of the system of FIG. 4.

### DETAILED DESCRIPTION

Systems and methods consistent with the present invention provides methods that enable the biopharmaceutical industry to access a large and varied group of individuals whose medical data, for example, demographic characteristics, genetic markers, biochemical markers, family histories, and medical histories, make them attractive candidates for medical research to advance disease diagnostics and therapies. Such systems and methods use a network of non-profit and/or for-profit organizations and partners that have not traditionally been involved in this area of significant medical research as a source for such individuals. For example, a network of collection establishments refers deferred donors and, optionally, accepted donors, into specific clinical studies and collects blood samples and information from both deferred and accepted donors for pharmacogenomic, genomic, or proteomic studies under Institutional Review Board (IRB)-approved procedures and informed consents.

Using systems and methods consistent with the present invention, entities conducting clinical studies have new access to an infrastructure of blood samples, personal medical information and individuals free of specific diseases and those who may have a specific disease(s) under research. Because individuals often donate blood on a regular basis over long periods of time, i.e., years, the methods of the invention permit the health of donors to monitored over an extended period of time and, furthermore, permit samples to be collected as an individual's medical condition changes.

The ability to propose participation in clinical research to blood and plasma donors enables the biopharmaceutical industry to locate individuals whose disease state, medical histories, and patterns of compliance within a regulated industry result in greater speed through the regulatory approval process and the arrival in the marketplace of life-enhancing diagnostics and therapies for the nation.

The pharmacogenomic interests of the biopharmaceutical industry can also benefit from using systems and methods consistent with the invention. For example, blood and plasma donors' blood and corresponding medical data are used in creating specific genomic and/or proteomic profiles that become benchmarks in the development of diagnostics or therapies for specific diseases. The company looking for the best candidates for a clinical trial on that disease, then focuses enrollment on patients whose profile fits the benchmark. Traditional large Phase III studies are made more efficient. This reduces the time and effort necessary to recruit large numbers of study patients and reduces the cost of drug development for many medicines.

In one implementation consistent with the present invention the problem of recruiting subjects into clinical trials is addressed by providing biopharmaceutical companies with access to a large, diverse population of individuals with well-documented medical histories and detailed clinical profiles. Clinical trial subjects may be recruited from a variety of sources, including, but not limited to, deferred donors and individuals with specific diseases identified through partnerships with physicians and medical centers.

Another implementation consistent with the present invention provides biopharmaceutical companies and researchers with access to a store of biological samples, including, but not limited to, whole blood, serum, proteins isolated from blood and nucleic acids isolated from blood, obtained with informed consent from a large, diverse population of individuals with well-documented medical histories and detailed clinical profiles. Currently available methods for collecting biological samples from diseased and healthy individuals for genomic and proteomic studies do not reflect the general population because the samples are often from inbred populations with a small founder population. Furthermore, many of these samples are obtained without proper, active informed consent, which is becoming more and more of a concern as the general public becomes aware of the potential monetary value of genetic studies. At present, most readily accessible sample collections represent rather small numbers of individuals and lack the ability to follow-up with the donors through a carefully controlled system that ensures privacy of the donor.

Yet another implementation consistent with the present invention facilitates the study of the inheritance of traits in the context of the entire DNA sequence complement of the organism, a branch of science known as genomics. In addition to analyzing the role of individual genes, genomics seeks to evaluate the importance of potentially highly complex interactions of multiple genes in health and disease. Of further interest is the investigation of an individual's response to treatment with a drug so as to correlate an individual's genetic makeup with drug effectiveness (or pharmacogenomics).

It is believed that, on average, any two individuals differ by only 0.1% in the approximately 3 billion base pairs that make up the genome. This, however, represents as many as 3 million differences, or polymorphisms. In most instances, these polymorphisms represent single base differences, and are thus known as single nucleotide polymorphisms (SNPs). Most of these 3 million or so SNPs lie outside of genes, which comprise only about 3% of the genome, and, in most instances, have no effect on the individual. Even for SNPs that lie within genes, most have no effect on the protein encoded by the gene because of the degeneracy of the genetic code. Benign or silent SNPs, however, may be useful if they co-segregate with a disease phenotype or if they indicate a specific response to drug therapy.

In some cases, the study of linkage or association of certain genetic markers with the disease state in well-characterized populations has enabled identification of a single gene defect that is both necessary and sufficient for manifestation of the disease. It also has been proven invaluable to have DNA samples from individuals with such so-called monogeneic disease, together with samples from genetically related individuals who do not show signs of the disease. Success also has been seen with populations of well-characterized, unrelated, individuals and matched controls.

The majority of common diseases, however, are rather more complex and are believed to result from the contribution of variations in a number of genes. The combination of certain mutations or polymorphisms can lead to a predisposition to develop a disease, though it is clear that environmental factors also contribute in many instances. In order to understand the etiology of these complex diseases, it is believed that the best approach is to collect large epidemiological study samples from many different populations (Peltonen et al., Science 291: 1224-1229, 2001). One implementation consistent with the present invention facilitates the collection of such large numbers of samples across a varied population.

The study of the human genome has further shown that there may be as few as 30,000 genes in the genome and, therefore, that much diversity must be provided through differences in the synthesis of messenger RNA and, subsequently, protein in different tissues. Consequently, it is important to be able to study the differences in the protein complement of individuals (the proteome) or changes in the posttranslational modification of proteins (both encompassed by the term “proteomics”), particularly any differences between healthy and diseased individuals. Unfortunately, while collections of samples from diseased individuals exist (though often without appropriate informed consent), there are generally no matching samples from those individuals prior to the development of the disease state, which severely limits the types of analysis that can be performed.

Another implementation consistent with the present invention facilitates the identification of such differences in protein expression between healthy and diseased individuals by providing samples from matched groups of healthy and sick individuals. By enabling the provision of large numbers of samples, techniques based on the pooling of samples from one or more groups of individuals can become particularly powerful. Still another implementation consistent with the present invention allows the proteomes of single individuals to be compared before and after disease development. And in a further embodiment, changes in the posttranslational modification of proteins can be investigated in healthy and diseased states.

Yet another implementation consistent with the present invention comprises a longitudinal database in which medical and demographic information for each donor, whether obtained through a collection establishment or through partnerships, is linked to genomic data for that donor, obtained, for example, through SNP analysis, and proteomic data for that donor, obtained, for example, through the analysis of the donor's proteome. These data are correlated with the subject's disease status and stored in a proteomics/genomics database. The samples collected from an individual over time for example, from that individual's first sample donation through either the development of disease in or death of that individual, also are stored and may be retrieved by accessing a longitudinal database of samples. The database may be queried in order to identify genomic and/or proteomic changes associated with the development of disease. Furthermore, as the database comprises vast amounts of data from large numbers of individuals, researchers are able to query the database in a hypothesis-free manner, as well as with hypothesis-driven queries. For instance, the vast amount of data can be queried for unexpected correlations of certain genomic and proteomic characteristics with disease phenotypes.

Another implementation consistent with the invention facilitates drug target identification and validation. Traditionally, potential drug targets have been identified on the basis of hypotheses from biochemical or pharmacological study of the disease state. Genomics allows the expansion of this approach to include searching the genome for genes encoding proteins with particular characteristics, or motifs, suggestive of classes of receptors or other classical drug targets or the study of changes in the expression of different nucleic acids. Alternatively, analysis of DNA samples for patterns of SNPs can be used to determine whether certain genotypes are associated with a particular disease, which may in turn lead to the identification of a new drug target. This latter approach requires samples of DNA from subjects with the target disease, together with a matched set of “healthy” controls.

Yet another implementation consistent with the invention facilitates research into the individual variability in response to drug treatment, which is a consequence of the genomic make-up of the individual. The study of this variability in response to drugs and its relation to the genetic markers (SNPs) in an individual provide the opportunity for selection of the most appropriate treatment, in terms of both efficacy and safety. This approach, known as pharmacogenomics, plays an increasingly important role, not only in the selection of the most appropriate treatment for an individual, but also in drug development by enabling the selection of the most appropriate subjects for clinical trials.

Reference will now be made in detail to implementations consistent with the present invention as illustrated in the accompanying drawings. Wherever possible, the same reference numbers will be used throughout the drawings and the following description to refer to the same or like parts.

Definitions

The term “collection establishment” as used herein refers to any blood or plasma organization contemplated as part of the invention. Collection establishments are typically regulated by the Food and Drug Administration or a similar agency. A collection establishment can be either an independent entity or owned by the contractor.

The term “end-user” as used herein means any entity that requests the names of donors or deferred donors fitting the profile for clinical trial subjects. End-users also include any entity that orders blood and/or DNA samples from a collection establishment for pharmacogenomic purposes and any entity that uses the longitudinal database of genomic/proteomic information.

The term “contractor” as used herein refers to an entity that acts by contract as an intermediary between collection establishments and end-users. A contractor may be an end-user. The contractor queries collection establishments for individuals or samples that meet the criteria established by an end-user and arranges the supply of contact information or of those samples to the end-user. The contractor also provides end-users with access to databases according to the invention. The contractor may audit end-users to ensure the proper use of the information or samples by the end-user under the terms of the contract. The contractor's role as an intermediary does not preclude the contractor from undertaking additional functions of the invention including, but not limited to, sample preparation, storage, and shipping, SNP analysis, and proteomics analysis.

The term “donor” as used herein means an individual who offers to donate or sell blood, plasma, or serum to a collection establishment. Donors fitting particular profiles also may be identified through partnerships with physicians, medical centers, and other health care providers.

The term “deferred donor” as used herein means an individual who offers to donate or sell blood, plasma, or serum to a collection establishment, but whose offer is refused, either temporarily or permanently, based on medical history or other relevant information.

The term “longitudinal” as used herein means obtained over a period of time. When the term “longitudinal” is applied to an individual or group of individuals, the period of time, in general, extends from an individual's first to last sample donations. The last sample donation may occur, for example, when the individual develops a disease, when the individual begins treatment of a disease, or upon the death of the individual. When the term “longitudinal” is applied to a sample or to information, the period of time may extend beyond the death of the individual from whom the sample or information was gathered.

As used herein, the term “pharmacogenomics” pertains to the correlation between an individual's response to treatment with a drug and that individual's genetic makeup. The term may be encompassed within the more general term “genomics”.

Overview of System Components and Operation

The implementation consistent with the invention may comprise a contractor, a network of collection establishments and, optionally, partners, and end-users. As exemplified below, systems consistent with the invention may be implemented using a computer network. Those skilled in the art will appreciate, however, that a manual implementation also may be consistent with the present invention. Systems consistent with the present invention enable end-users, for example, biopharmaceutical industry consumers, to select clinical trial participants, DNA samples, and tissue samples from subjects suitable for drug development studies and clinical trials. Suitable subjects will vary from study to study and may be selected based on criteria such as age, sex, ethnicity, or race. The skilled artisan will recognize, of course, that many other selection criteria also may be appropriately applied depending on the particular requirements of the study.

Donor Information and Sample Collection

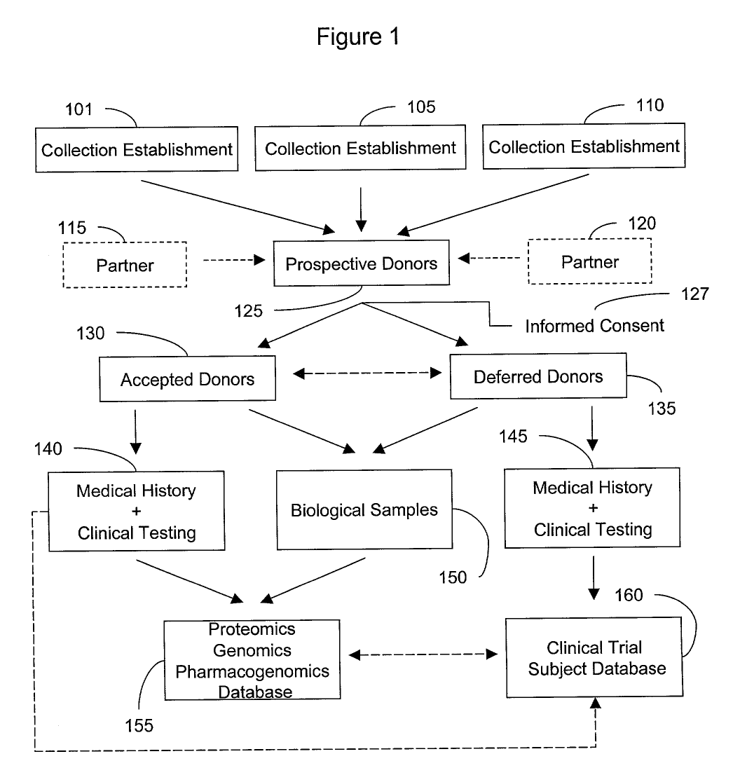

As diagrammed in FIG. 1, multiple collection establishments 101, 105, and 110 are intake sites for prospective donors 125, optionally in collaboration with one or more partners 115 and 120. The collection establishments obtain informed consent 127 from prospective donors in compliance with Institutional Review Board-approved procedures permitting, for example, the use of donated tissue samples in biomedical research and/or the release of the information needed to contact an individual to pharmaceutical companies seeking clinical trial subjects or research subjects. The collection establishments also collect donor demographic information, family histories, and medical histories 140 and 145, and, optionally, perform clinical chemistry analyses on donor samples 150 (any and all such information being generally defined as “medical data”). Table 1 provides examples of the type of information requested from prospective donors and the types of clinical tests performed on the blood of prospective donors. A non-exclusive list of other possible tests, which may be performed either singly or in various combinations, are included in an Appendix.

TABLE 1

| | |
|---|---|
| Demographic Information | recent surgery |
| donor name | recent dental work |
| donor social security number | taking any medication |
| donor address and zip code | taken human growth hormone |
| donor phone-work and home | taken Tegison |
| donor birth date | taken Accutane |
| donor race | taken Proscar |
| donor gender | syphilis |
| donor employer | gonorrhea |
| Donation Profile | pregnant |
| date of last donation | blood transfusion |
| total number of donations | organ transplant |
| blood (ABO/RH) type | tissue transplant |
| Health History | tattoo |
| weight | ear or skin piercing |
| temperature | contact with another's blood |
| pulse | exposure to hepatitis |
| blood pressure | exposure to Creuzfeldt-Jacob |
| hemoglobin/hematocrit | disease |
| recent flu | used a needle to take drugs |
| recent cold | given money for sex |
| recent sore throat | given drugs for sex |
| skin problems | taken money for sex |
| rashes | taken drugs for sex |
| any immunization | sex with someone who has taken |
| chest pain | money for sex |
| heart disease | sex with someone who has taken |
| lung disease | drugs for sex |
| cancer | men-sex with a man since 1977 |
| blood disease | women-sex with a male who had |
| bleeding problem | sex with a man since 1977 |
| yellow jaundice | taken clotting factor concentrate |
| hepatitis | sex with someone who has taken |
| malaria | clotting factor concentrate |
| Chagas disease | AIDS |
| babesiosis | positive test for AIDS |
| under a doctor's care | sex with someone who has AIDS |
| received blood transfusion in | sex with someone who has HIV |
| African country | antibody |
| had sex with someone from | travel outside U.S. or Canada |
| African countries | born or lived in African countries |
| transfusion-associated AIDS | since 1977 |
| transfusion-associated Hepatitis | Hepatitis B screening |
| Laboratory Screening Tests | Hepatitis B Core Antibody screening |
| antibody screening results | Hepatitis C screening |
| alanine aminotransferase (ALT) | Human immunodeficiency virus |
| Cytomegalovirus (CMV) screening | (HIV) Types 1 & 2 screening |
| Additional data maintained on | Human T-celI lymphotropic virus |
| plasma donors | (HTLV)-1 screening |
| breastfeeding now | HIV Antigen screening (9) |
| close contact with someone with | PCR test (HAV, HBV, HCV, HIV, |
| jaundice | Parvovirus B 19) |
| Varicella-Zoster (live) | Serum protein electrophoresis (SPE) |
| Hemophilus Influenza type B- | tetanus |
| | prison or jail in past 12 months |
| | atypical Anti-D Antibody |
| | antibiotics within the past 14 days |
| | urinalysis |

Additional information of use to the end-user may be collected, either prospectively or retrospectively. One skilled in the art will readily recognize that the nature of the donor information requested is dictated by the requirements of the study in which the donated sample is to be used.

The information collected is gathered by any available mechanism, including, but not limited to, confidential, personal interviews, the use of self-executed forms, or even by direct entry into a computerized database, for instance via a personal computer terminal or via a hand-held device. The information collected from prospective donors may be generally the same as is collected at present by collection establishments and is maintained in confidence.

The existing infrastructure of the blood and plasma industry may be employed to collect information from donors. Individuals collecting information are trained to comply with Standard Operating Procedures (SOPs) developed for the business. The training of individuals responsible for collecting donor information is documented and entered into the individual's permanent personnel record. Individuals collecting information from donors are located either at the site of the collection establishment or at one or more remote locations separate from the point of contact for blood and plasma donors. These individuals also are equipped to explain and administer informed consents. The informed consent describes, for example, the fact that information of a personal and/or familial nature is requested by an end-user, for example, a pharmacogenomic, biotechnology, or pharmaceutical company, developing treatment or drugs to help cure specific diseases. If the nature of the disease to be studied is known, this information may be disclosed in order to engage the interest of the donor.

Informed consents are maintained by the collection establishments, or, alternatively, by a contractor, preferably in donor files. It is not contemplated that the names or informed consents of individual donors are disclosed to clients. Rather the collection establishment provides the client with evidence of informed consent, for example, a Verification of a Signed Informed Consent Form accompanying donor-derived samples. If desired, audits performed at the request of the client and, preferably, conducted by an independent third party, assure the client that proper informed consents have been administered. In addition, since most of the data collected from donors is entered into a computer, all appropriate firewalls of confidentiality and privacy are, of course, employed. The signature for the Informed Consent may be implemented using digital signature techniques.

To further protect the identity of donors, the invention employs alphanumeric strings, rather than names, to identify each donor. Such strings may be assigned by either the contractor, the collection establishment, or the client. The collection establishment may assign unique, confidential identification numbers to donors. The collection establishment may also assign a unique, confidential identification number to each sample collected from a donor. Presently, a unique one-time number is assigned to the product donated in both the whole blood and the plasma industries. In implementation consistent with the invention, these numbers are used to identify sample and donor information.

Based on the prospective donor's answers and test results, the individual is classified either as an accepted donor 130 or as a deferred donor 135. Medical history and clinical testing data along with the results of proteomic and genomic analyses of both accepted and deferred donors are combined to make the proteomics and genomics database 155.

The clinical trials database 160 comprises data collected from deferred donors. Optionally, the clinical trials database also may comprise data collected from accepted donors

Data collected from donors are kept in perpetuity. As requested by an end-user and in compliance with an IRB-approved informed consent, donors are, from time to time, asked to supply additional and/or updated information. All such updates are incorporated into the permanent record of the donor.

Method for Identifying Clinical Trial Subjects

One implementation of the invention provides a method for identifying a research subject, comprising: a) obtaining medical data from a subject; b) associating an identifier for said subject with said medical data in at least a first database; c) associating the identifier for said subject with the name and contact information of said subject; d) identifying criteria for selecting a research subject; e) extracting an identifier from the first database, wherein said identifier is associated with a subject matching the identified criteria; and f) matching the identifier from the first database with the name and contact information in order to identify the research subject.

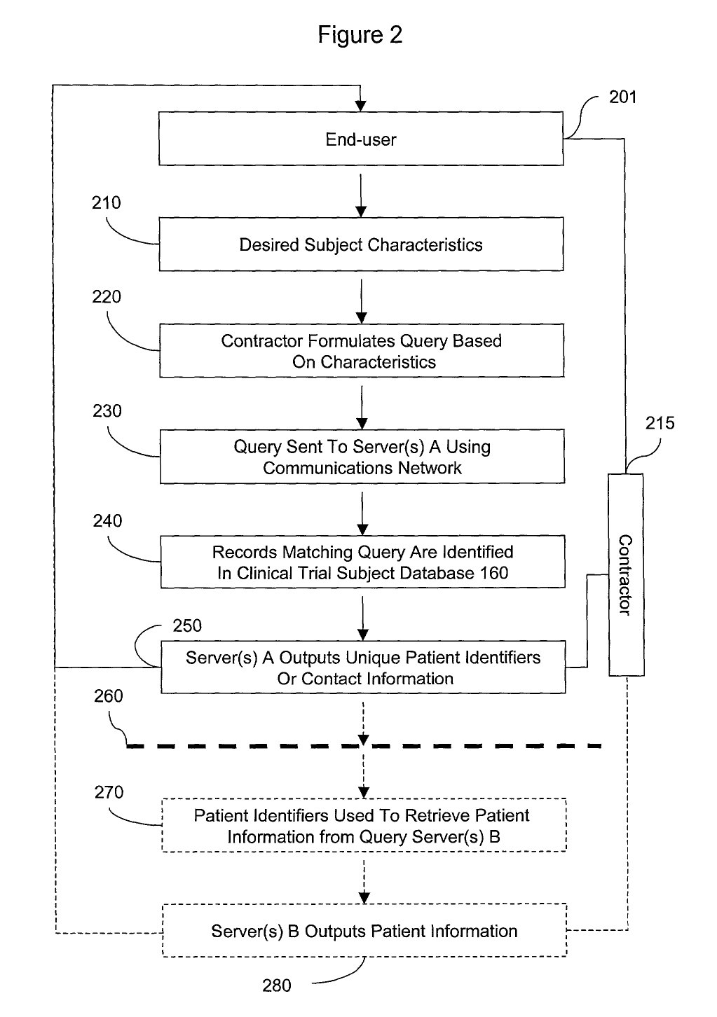

A request to identify potential clinical trial subjects originates with an end-user 201 (see FIG. 2). The end-user provides desired subject characteristics 210 to the contractor 215. For example, the end-user may wish to identify individuals with specific pharmacogenomic characteristics, e.g., relating to a cytochrome P450. Based on those characteristics, the contractor formulates a query 220, which is designed to interrogate the clinical trials database 160 for subjects with the desired characteristics. The query is sent to Server A, which comprises the clinical trials database, over a communications network 230. Records in that database that satisfy the query are identified 240 and output as unique patient identifiers by Server A 250.

In one implementation consistent with the invention, the name and contact information associated with each identifier also are stored in the clinical trials database 160.

In another implementation consistent with the invention, the name and contact information associated with each identifier are stored in a second database, which cross references the unique patient identifiers with the names and contact information of the corresponding individuals.

In one implementation consistent with the invention, the clinical trials database and the second database are stored on Server A. In another implementation, the second database is stored on a separate Server B 270. In implementations of the invention utilizing Server B, Server A may be either directly linked to Server B through a firewall 260 or, alternatively, freestanding and without links to other components of the communications network. Information is retrieved from Server B either through the communications network if a link is present in the system or manually if Server B is freestanding.

In general, the contractor or the collection establishment contacts individual identified and seeks permission to pass patient contact information 280 on to the end-user. Alternatively, the patient information 280 may be sent directly to the end-user, who then contacts the individuals identified or, alternately, further refines the query for resubmission to the contractor.

Although the invention does not contemplate directly releasing data, other than names and contact information, supplied by individual donors to end-users, donors are, on occasion, asked for permission to release demographic information. Such demographic information is only released in confidence to end-users and without disclosing the identity of the individual(s) from whom that information was collected. Additionally, from time to time, and with donor consent, the results of donor testing for viruses, including, but not limited to, hepatitis B virus (HBV), hepatitis C virus (HCV), and human immunodeficiency virus (HIV), are disclosed to end-users.

Method for Establishing a Proteomics/Genomics Database

As illustrated in FIG. 1, biological samples 150 are collected from both accepted and deferred donors. The sample collected is generally whole blood, but other tissues may be collected, especially in collaboration with partners. Portions of each sample are stored as whole blood or as any fraction of whole blood (e.g., serum, lymphocytes, erythrocytes, etc.) and as nucleic acids derived from such whole blood or fraction of whole blood. Donor DNA and RNA are extracted using methods, either manual or automated, known to those skilled in the art.

Donor samples are stored under standard conditions known in the art, preferably at a centralized depository maintained by the contractor, although storage at multiple sites, which may be maintained by third parties, is consistent with the invention. In one embodiment, stored samples are bar-coded with unique identifiers to facilitate their identification and retrieval from storage. The facility for sample handling and storage may include a system for robotic handling and retrieval of individual samples.

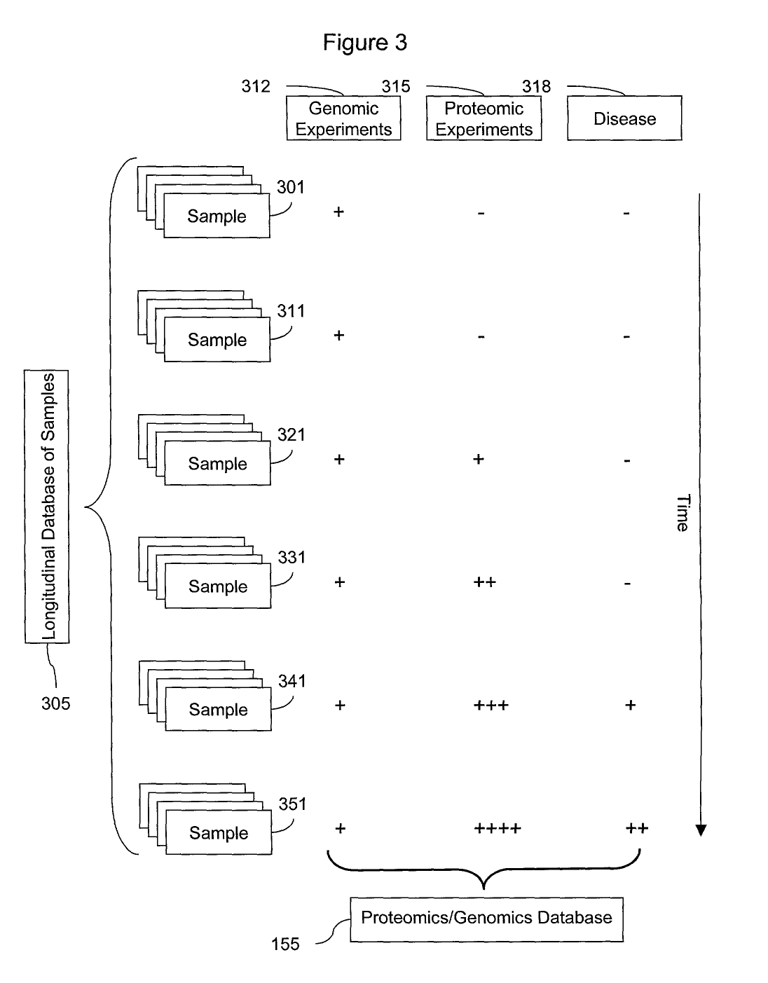

As illustrated in FIG. 3, samples 301, 311, 321, 331, 341, and 351 are collected from the same individuals repeatedly over time, in general over years. These samples are stored as described above and constitute a longitudinal sample database 305. The longitudinal sample database comprises at least 2 samples, and may comprise at least 50, at least 1000, at least 10,000, at least 500,000, at least 1,000,000, at least 5,000,000, or at least 10,000,000 samples. Samples are retrieved from the longitudinal sample database on demand to satisfy the needs of the contractor or of an end-user.

In addition to the data in Table 1 and, optionally, additional information from other tests, for example, listed in the Appendix,, which are associated with each sample, genomic experiments 312, for example, to detect SNPs or to monitor changes in gene expression, and proteomic experiments 315, for example, to detect aberrant protein expression or changes in the posttranslational modification of proteins, are performed on each sample either at the time the sample is acquired or retrospectively, for example to search for changes in DNA sequence, RNA expression, or protein activity that are associated with a later-arising disease 318.

An example of information that may be stored in the proteomic/genomics database is shown in FIG. 3. Assays performed on samples 301 and 311, which are collected from the same individual at different times, show a DNA polymorphism (e.g., a SNP), but show normal RNA and protein expression. At the times samples 301 and 311 are collected, the individual shows no sign of disease. Assays performed on samples 321 and 331, again collected from this individual but at later times, as before show a DNA polymorphism and now also show abnormal expression of at least one protein and/or RNA. The amount of abnormal expression increases between the date sample 321 is collected and the date sample 331 is collected. At the time sample 341 is collected, the individual has begun to show disease symptoms. The DNA polymorphism persists and the extent of abnormal protein/RNA expression has increased. The DNA polymorphism persists in sample 351, but the abnormal protein and/or RNA is more or less abundant. Disease severity has worsened at the time sample 351 is collected, suggesting that the DNA polymorphism and the expression abnormality may be diagnostic for the disease and may be therapeutic targets.

Databases

Donor information and data associated with samples (e.g., storage location, SNP profile, etc.), collectively “information,” may be stored using any method that permits high productivity, scalability, flexibility, accessibility, security, correctness and consistency of housed data, data granularity, and presentation. The storage system may be a computerized database. In one implementation consistent with the invention, the information is stored in a secure, computerized data warehouse system, accessible only by controlled passwords assigned to trained users. In general, collection establishments currently use this type of system for data storage. The data warehouse is designed using dimensional modeling, a logical design technique that seeks to present the data in a standard framework that is intuitive and allows for high-performance access. This type of modeling provides the optimal balance among critical factors such as productivity, scalability, flexibility, accessibility, security, correctness and consistency of housed data, data granularity, and presentation.

A centralized database of information is generally maintained by the contractor, although systems for housing all or part of a database may be distributed at different sites.

In one implementation consistent with the invention, end-users provide the contractor with criteria through which the desired donors and samples may be identified. The contractor causes the donor data and sample information database or databases to be searched using queries developed using the client-supplied criteria. Standard query protocols are used, resulting in the data required for the end-user. In general, a query tool set is selected that allows for services such as warehouse browsing, query management, standard reporting, access and security.

Database queries are performed by trained employees either of the contractor or of the collection establishments. Database queries may be performed by the contractor, by employees of the collection establishments, who, as part of their normal jobs, query the databases for routine purposes of the collection establishments, or by end-users, following protocols establishing confidentiality and proper security. The result of a query is the approach to an individual donor to participate in a client's research, the shipment of sample to the client, or the identification of desired proteomic/genomic information.

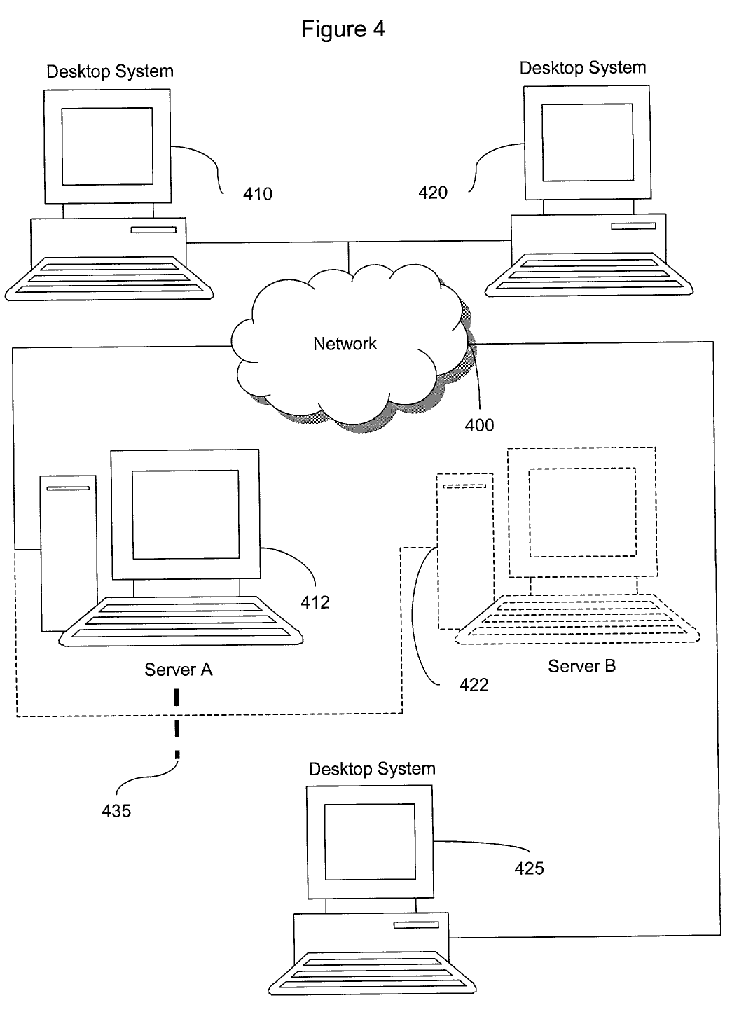

It will be appreciated that the present invention may be implemented in a software system, which is stored as executable instructions on a computer readable medium accessible either directly or through a network. FIG. 4 illustrates a conceptual diagram of a computer network 400 in which methods and systems consistent with the present invention may be implemented to permit users to query a database of donor and sample information. Computer network 400 comprises one or more small computers (such as desktop computers, 410, 420, and 425) and one or more large computers (such as Server A 412 and server B 422). In general, small computers are “personal computers” or workstations and are the sites at which a human user operates the computer to make requests for data from other computers or servers on the network. Usually, the requested data resides in the large computers, but the size of a computer or the resources associated with it do not preclude the computer's acting as the home of a database. In one implementation consistent with the invention, Servers A and B are connected through a firewall 435, which permits secure access to information that identifies donors to authorized users. In another implementation consistent with the invention, Servers A and B are not connected by a network and patient information must be accessed directly from server B.

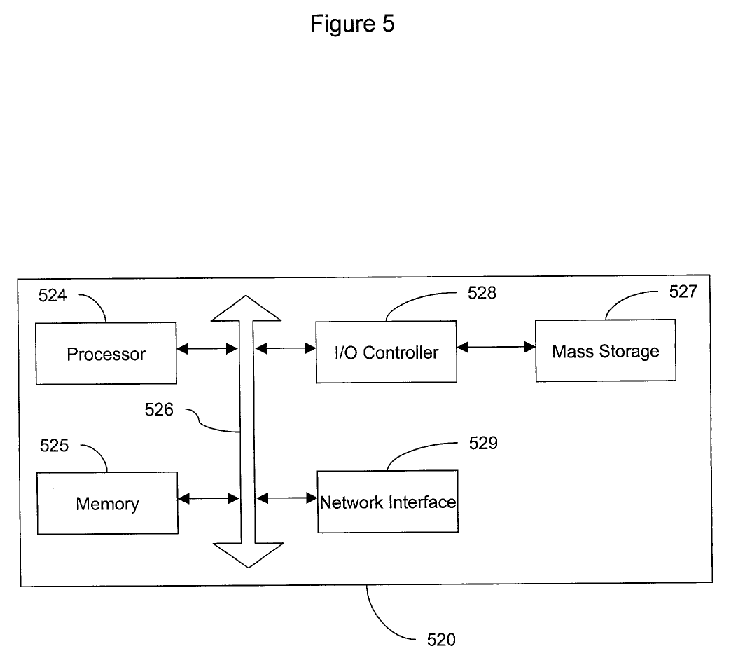

Desktop computer systems and server systems compatible with the invention includes conventional components, as shown in FIG. 5, such as a processor 524, memory 525 (e.g., RAM), a bus 526 which couples processor 524 and memory 525, a mass storage device 527 (e.g., a magnetic hard disk or an optical storage disk) coupled to processor 524 and memory 525 through an I/O controller 528 and a network interface 529, such as a conventional modem or Ethernet card.

The distance between a server 412 and a desktop computer 410 may be very long, e.g., across continents, or very short, e.g., within the same building. When the distance is short, the network 400 is preferably a local area network (LAN). When the distance between server 412 and desktop computer 425 is long, the network 400 may, in fact, be a network of networks, such as the Internet. In traversing the network, the data may be transferred through several intermediate servers and many routing devices, such as bridges and routers. Proper security and flexibility of access will be employed to provide authorized access through commonly used interface technologies.

The software system of the present invention is, for example, stored as executable instructions on a computer readable medium on the desktop and server systems, such as mass storage device 527, or in memory 525. Access to the system described above is available on a single-use or on a multiple-use basis. Preferably, end-users contract with the contractor for continuing access to the system.

The foregoing description of implementations of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The invention may be implemented with both object-oriented and non-object-oriented programming systems. The scope of the invention is defined by the claims and their equivalents.

APPENDIX

| | |
|---|---|
| 1,1,1-Trichloroethane, Blood | Ketone Bodies, Serum |
| 1,25-Dihydroxy Vitamin D3 | Ki67 |
| 11 DEOXYCORTISOL | Kidney Stone |
| 11-Desoxycortisol | Killer Weed |
| 17-Hydroxycorticosteroids | KLEIHAUER-BETKE |
| 25-Hydroxycalciferol | Klonopin TM |
| 3-A-ANDROSTANEDIOL | KOH |
| 3-Methoxy-4-Hydroxymandelic Acid | L/S Ratio |
| 4-AMINOANTIPYRINE | Labile Factor |
| 5′ Nucleotidase | Lactate |
| 5-HIAA | Lambda Light Chains, Urine |
| 5-NUCLEOTIDASE | Lanoxin ® |
| 5T Allele Genotyping | LAP |
| A, Vitamin | LASA |
| A-1 Apolipoprotein | Latex |
| A1A Phenotyping | LAXATIVE ABUSE SCREEN |
| A1-Antitrypsin | L-Carnitine, Total, Free, and Esters |
| A-1-ANTITRYPSIN | LCM |
| Abnormal Bleeding Profile | LD |
| ABO | LD, Body Fluid |
| ABSCESS AFB CULTURE | LDH |
| AC Globulin | LDL |
| ACA | LEAD |
| ACE | Lecithin/Sphingomyelin Ratio |
| ACH R AB | Legionella Antibodies, IgM |
| Acid Anhydride Profile | LEISHMANIA CULTURE |
| ACT LOW RANGE-MEDTRONIC | LEPTOSPIRA CULTURE |
| ADENO AG BY DFA | Lesion Culture |
| ADH | Leu3A |
| ADRENAL ANTIBODIES | LGV |
| ADVIL | LH |
| AEROBIC CULTURE | LHRT |
| AFB BLOOD CULTURE | Li, Blood |
| AFP | Librax ® |
| AGBM | LiCO3 |
| ALA | LIDOCAINE |
| Albumin | Li-Fraumeni Syndrome (p53) |
| ALCOHOL PANEL | LILEY CURVE, AMNIOTIC FLUID |
| ALDOLASE | LIPASE |
| Alk Phos | Liquiprin ® |
| ALPHA 2 ANTIPLASMIN | LITHIUM |
| ALT | Liver Cancer Monitor Profile |
| ALUMINUM | LKM-1 Antibodies |
| AMA | Loa loa Smear |
| AMIKACIN | Long chain 3-hydroxyacyl-CoA dehydrogenase |
| AMMONIA | LORAZEPAM |
| AMNIOTIC FLUID | Loss of Heterozygosity |
| AMOBARBITAL | Low-Density Lipoprotein Cholesterol (Direct) |
| AMPHETAMINE | LOXAPINE |
| AMYLASE | LP |
| ANA | Lp(a) |
| ANCA | LRP |
| ANDROSTENEDION | LSD Screen, Urine |
| ANGIOTENSIN CONVERTING ENZYME | LUKENS-TRAP |
| ANTI GBM | Lumbar Puncture |
| APC Mutations in FAP | Lung, Adenocarcinoma Monitor Profile |
| APOLIPOPROTEIN A1 | Lupus Anticoagulant |
| APTT | Luteinizing Hormone (LH) and (FSH) |
| ARGININE VASOPRESSIN | Lyme Disease (Borrelia burgdorferi) by PCR |
| ARSENIC | Lysergic Acid Diethylamide, Urine |
| ASCORBIC ACID | M PNUEMONIA ANTIBODY |
| ASMA | MAC BLOOD CULTURE |
| ASO (ANTI-STREPTOLYSIN O) TITER | MAGNESIUM |
| ASPARTATE AMINOTRANSAMINASE | MAI BLOOD CULTURE |
| AST | MALARIA |
| AT III | Manganese, Blood |
| a-Thalassemia | MAPROTILINE |
| AURAMINE STAIN | Marijuana |
| AUTOMATED DIFFERENTIAL | Maternal Serum Alpha-Fetoprotein |
| AVP | MAXIMUM BACTERICIDAL DILUTION |
| B CELL CYTOTOXIC CROSSMATCH | MBC |
| B SURFACE ANTIGEN | MBD |
| B VIRAL DNA | MBK, Blood |
| B.PERTUSSIS CULTURE | MBP |
| B1 Vitamin, Plasma | MCH |
| B12 | MCV |
| B-19 PCR | MDA |
| B27 | MDMA |
| B2-MICROGLOBULIN | MEAN CELL HEMOGLOBIN CONCENTRATION |
| B6, Vitamin | Mebaral ® |
| Bacterial Antigens (Serum, Urine, Cerebrospinal Fluid) | MECONIUM DRUG SCREEN |
| BAL FOR CMV CULTURE | Medium chain acyl CoA dehydrogenase (MCAD) |
| BANDS | Megaloblastic Anemia, Serum |
| BARBITAL | MEK, Blood |
| Basic Metabolic Panel | Melanoma Monitor Profile |
| BAYER ENCORE QA PLUS, GLUCOSE | MENINGOCOCCUS GROUPS (A,B,C,Y,WI 35) |
| BB | Meperidine (Demerol ®), Serum |
| B-Cell Gene Rearrangements, Ig Heavy Chain | MERCURY |
| BCL-2 t(14; 18) Translocation | Mesoridazine (Serentil ®), Serum |
| BCR-ABL t(9; 22) Translocation | Metabolic Dysglycemia Profile |
| BCSF | Mexate ® |
| BENADRYL | Mg, RBC |
| Beta Apolipoprotein | MGC GROUP B (SpinalFI) |
| Beutler-Baluda Test | MHA-TP |
| BGP | MIA Test |
| B-hCG Quantitative, Serum | MIBK, Blood |
| Bi, Blood | MIC |
| BICARBONATE | Midstream Urine Culture, Routine |
| Bile Acids | MILTOWN |
| Bioavailable Testosterone | MINIMUM BACTERICIDAL CONCENTRATION |
| BISCODYL | Miscellaneous Fluid Cytology |
| Bladder Tumor Antigen (BTA) Cytology Profile | Mitochondrial Ab |
| BLEEDING TIME | MMAC |
| Blood Acetone | MMR |
| BODY FLUID | Mn, Blood |
| Bone Alkaline Phosphatase (BAP) | MNBK, Blood |
| BORDETELLA PERTUSSIS CULTURE | MODIFIED ACID FAST STAIN |
| BRAIN BIOPSY | Mold Culture |
| Breast | MONO SCREEN |
| BROMPHENIRAMINE | Morphine |
| BRUCELLA AGGLUTININ | MOTRIN |
| BSAB | MPO-ANCA |
| BSF-2 | MRSA Culture |
| BTA | msAFP |
| b-Thalassemia (Cooley's Anemia, Mediterranean Anemia | MTB, PCR (With Culture) |
| BUFFY COAT FOR CMV | MTD |
| BUN | MTX, Blood |
| BUPROPION | Mucin Clot Test |
| BUTABARBITAL | Multiple Endocrine Neoplasia (MEN2A) |
| C, Vitamin | MUMPS |
| C. DIFF TOXIN | MURAMIDASE TEST |
| C.DIFF CULTURE | MUSCLE BIOPSY |
| C1 Esterase Inhibitor | Myasthenia Gravis Antibody |
| C1EI | MYCO-M |
| C1Q | Myelin Basic Protein (MBP), Cerebrospinal Fluid |
| C2 Complement | Myidone ® |
| C3 | MYOGLOBIN |
| C3c | MYSOLINE |
| C4 | Na |
| C4, Body Fluid | NA |
| Ca | N-ACETYLPROCAINAMIDE |
| Ca, Urine | NAPA |
| Ca++, Ionized, Serum | NARCOLEPSY ASSOCIATED ANTIGEN |
| CA-125 | Nasal Smear for Eosinophils |
| Cachectin | NATIVE DNA |
| CADASIL | Navane ® |
| CAE | NBT |
| CAFFEINE | N-DESALKYLFLURAZEPAM |
| CALCITONIN | Nebcin ® |
| cAMP, Urine | Necropsy |
| Canavan Disease, DNA Analysis | Neisseria gonorrhoeae by DNA Probe |
| C-ANCA-Specific Antibody | NEMBUTAL |
| Cancer Antigen (CA) 125 | Neopterin |
| CARBAMAZEPINE | NERVE BIOPSY |
| CATECHOLAMINES | Neuroblastoma Monitor Profile |
| CBAVD | NEWBORN HEMOLYTIC DISEASE WORKUP |
| CBC | NF-1, Known Mutation |
| Cd, Blood | NGI SuperQuantTM |
| CD25 | NH3 |
| CD3 | NH4 |
| CD4 | Ni, Plasma |
| CD8 | Nickel, Plasma |
| CDF | Niemann-Pick Disease, DNA Analysis |
| CEA | Nipple Discharge |
| Celiac Disease (CD) Antibodies | NITROBLUE TETRAZOLIUM, CGD |
| Centrax ® | NKH1A, Leu19 (for CD56) |
| c-erbB-2 | N-Methylacetamide |
| CEREBROSPINAL FLUID (CSF) CULTURE | NMP 22 |
| CF Carrier | Nongonococcal Urethritis Culture |
| CH50 | Noradrenaline, Plasma |
| Chain-of-Custody Protocol, Specimen | Nose Culture |
| CHEM 10 | NSE |
| Chickenpox Culture | N-Telopeptide |
| CHLAMYDIA | NTX Test |
| Chol | Nuclear Matrix Protein (NMP) 22 |
| Christmas Factor | O AND P |
| Circulating Anticoagulant | O2CT |
| CITRATE | OB HOLD REQUEST |
| CK | OCCULT BLOOD |
| CK, Serum | Ocular Cytology |
| CK-2 | OD 450 |
| Cl | OGTT |
| Cl, CSF | OKT3 (CD3) |
| CLB Smear | Oligoclonal Banding |
| Clearance, Creatinine | ON SERVICES/BLOOD BANK |
| Clomipramine (Anafranil ®), Serum | ONE HOUR GDM |
| CMV | Opiate Confirmation, Urine |
| CO, Blood | ORAL CYTOLOGY |
| CO2 | Orbinamon ® |
| COAG FACTOR CONCENTRATES | Organism Identification |
| Cobalamin, True | Ornithine transcarbamylase deficiency (linkage assay) |
| COCAETHYLENE-COCAINE ANALOG | Oropharyngeal Brushings Cytology |
| Codeine | Osmol |
| Coke | Ostase ® |
| Cold Agglutinin Titer, Quantitative | OVA AND PARASITE |
| Combined Esterase (CES) | OXALATE URINE |
| COOMBS CROSSMATCH | Oxidative Stress Analysis |
| COPPER | OXYCODONE |
| CORD ISOHEMAGGLUTININS | P |
| COTININE | P AND P TEST |
| Coumadin ® | P. carinii Pneumonia, Stain |
| Coxiella burnetii Antibodies | p24 Antigen |
| C-PEPTIDE | PABA |
| CPK | Packed Cell Volume |
| CPPT | PAIGG, PAIGA, PAIGM |
| Cr, Plasma | Pamelor ® |
| Crack | P-ANCA-Specific Antibody |
| C-REACTIVE PROTEIN | Pancreatic Cancer Monitor Profile |
| Creat | PAP |
| CRM Assay | PARA 3 AG DFA |
| CROSSMATCH TEST EA UNIT | PAS |
| CRP | Paternity Studies |
| CRYO | Pb, Blood |
| CSA | PBG DEAMINASE, ERYTHROCYTE |
| CSF AFB CULTURE (SpinalFl) | PCB Exposure Profile, Plasma |
| cTnI | PCO2 |
| Cu, Plasma | PCP |
| CULTURE FOR B.PERTUSSIS | PCR-CMV (SpinalFl) |
| Cutaneous Immunofluorescence, Indirect | PCV |
| CVS Prenatal Karyotyping, Chromosome Analysis | PEDIGREE RECONSTRUCTION |
| CYANIDE | PENTAZOCINE |
| CYCLIC ADENOSINE MONOPHOSPHATE | PEPSINOGEN |
| Cyst Fluid Amylase | PG and Creatinine, Amniotic Fluid |
| CYTOLOGY, “RUSH” OR “SAME DAY” | PG, Amniotic Fluid |
| D | PH |
| D Factor | pH, Body Fluid |
| D XYLOSE 5 HOUR TOLERANCE URINE | Phagocytosis |
| DALA | PHENAZOPYRIDINE |
| DANTHRON | Philadelphia Chromosome |
| DARKFIELD EXAM | Phos |
| DAT | PHYTANATE |
| DAZ+ Analysis | Pi Phenotype |
| D Bili | Pill Analysis |
| DCC Allelotyping | Pinworm Preparation |
| D-DIMER | Pituitary Glycoproteins, Alpha Subunit |
| DDT Exposure Profile | PKU |
| DEHYDROEPIANDROSTERONE | PLACENTA EXAMINATION |
| DELTA | PLEURAL FLUID |
| DEMEROL | PLP |
| DEOXYCORTICOSTERONE | PLT |
| DEPAKENE | PNEUMO LATEX AGGLUTINATION |
| Dermatophyte Culture | PO2 |
| DES | PO4 |
| Dexedrine ® | POLIO 1 ANTIBODY |
| DFA FOR CHLAMYDIA | PORCINE FACTOR VIII INHIBITOR TITER |
| DHEA | Postmortem Examination |
| DHT | POTASSIUM |
| Diazepam, Serum | PP Glucose, Two-Hour |
| DIBUCAINE | PPH |
| DIC Profile | PPLO Antibodies |
| DIFF | PPP |
| Digitalis | PR3-ANCA |
| Dihydrotestosterone | PRA |
| DIL | Prealbumin |
| Dimethylacetamide Exposure Profile | PRIMIDONE |
| DIPHENHYDRAMINE | Proaccelerin |
| DIRECT ANTIGLOBULIN | PRUSSIAN BLUE STAIN |
| Disease Association | pS2 Protein, Paraffin Block |
| DITHIONITE TEST | PSA |
| DMAC | PSEUDOCHOLINESTERASE |
| DMD/BMD | PSITTACOSIS |
| DNA Analysis for Parentage Evaluation | PT |
| Dolophine ® | PTH Intact |
| DOPAMINE | PTT |
| DORIDEN | Punch Biopsy |
| DOUBLE-STRANDED DNA | PURKINJE CELL CYTOPLASMIC AB TYPE 1 |
| DOXEPIN | PUS CULTURE |
| Dpd | PYRALINKS-D |
| D-PYRALINKS | Q FEVER |
| DQ1 | QUAALUDE |
| DR Transplant | Quick-Cult ® |
| DR2 | RA Latex |
| DRAINAGE CULTURE | Random Blood Glucose |
| DRVVT | Rapid Grower Susceptibility Testing |
| DS-DNA | Rash Profile A |
| Duraquin ® | RBC Cholinesterase |
| d-Xylose Absorption Test | Recombinant Immunoblot Assay |
| E. coli 0157:H7 | Red Blood Cell (RBC) Antigen |
| E.HISTOLYTICA CULTURE | Reference Bacterial Culture Identification |
| E1 | Rela ® |
| E2 | Renal Function Panel |
| E3, Serum | Replication Error |
| Ear Culture | RER |
| EBV | Resistance Analysis |
| ECG Cardiologist Overread Only, Adult | RET Mutations In MEN 2 And FMTC |
| ECTODERMAL DYSPLASIA (LINKAGE ANALYSIS) | Reverse T3 |
| ED STAT PANEL A | RF Assay |
| Effusions Cytology | Rh Factor |
| EGFR | Rheumatic Fever Profile |
| EHEC, Stool Culture | Rh-hr Genotype |
| ELAVIL | Rho(D) Typing |
| Electrolyte Panel | RIBA HCV |
| ELISA ANTIBODY SCREEN | Rickettsia rickettsii Titer |
| ELUTION | Ristocetin Cofactor |
| ELVIS ® | Ritalin ® |
| Endep ® | RMSF IgM Antibodies |
| ENGRAFTMENT STUDY | Rocket Fuel |
| ENTAMOEBA HISTOLYTICA CULTURE | Rotavirus, Direct Detection by Immunoassay |
| Environmental Culture | Routine Culture, Stool |
| Eos Count | RPR |
| EP | RSV by DFA |
| EPG SERUM | Rubella Antibodies, IgG |
| EPHEDRINE | S. pneumoniae Antigen |
| Epidermal Growth Factor Receptor (EGFR) | Saccharomonospora viridis |
| EPO | Salicylate, Serum |
| Epstein Barr Virus (EBV) Antibodies | Sandimmune ® |
| ER/PR Assay | Sb, Urine |
| Erythrocyte Count | Scleroderma Diagnostic Profile |
| Eskalith ® | Scotch ® |
| ESOPHAGEAL BRUSHING CYTOLOGY | Se, Blood |
| ESR | Secobarbital |
| Essential and Metabolic Fatty Acids Analysis | Sedimentation Rate, Westergren |
| Esterase Inhibitor | Selenium, Blood |
| ETHANOL (NOT FORENSIC) | Semen Analysis, Basic |
| EtOH | Sensitivity Testing |
| Etrafon ® | Serentil ® |
| Excedrin ® | Seven Drugs Plus Ethanol |
| Extrinsic Factors | SEX DETERMINATION |
| Eye | SGOT |
| F, Plasma | SGPT |
| FA FOR B.PERTUSSIS | SHBG |
| Factor B | Shingles Culture |
| Familial Adenomatous Polyposis (FAP) | Sickle Cell Anemia (Hb SS or SC) |
| FANA | Siderophilin |
| FAP Analysis, Known Mutation | Silver, Plasma |
| Farmer's Lung | Sinequan ® |
| Fast Hemoglobins | Sjögren's Antibodies (Anti-SS-A/Anti-SS-B) |
| FAT STAIN | Skeletal Alkaline Phosphatase (SALP) |
| FBS | Skin Biopsy ((To be assigned by pathologist)) |
| FDP, Plasma | SLE |
| Fe | SM-C/IGF-1 |
| FECAL CULTURE | Smooth Muscle Antibodies |
| FELBAMATE | Snow |
| Female Hormone | Sodium Fluoride |
| FEP | Soluble Transferrin Receptor |
| FERN TEST | Soma ® |
| FETAL FIBRONECTIN | Soprodol ® |
| FFP | Soridol ® |
| FIBRIN SPLIT PRODUCTS | SPCA |
| FINE NEEDLE ASPIRATE CYTOLOGY | Specific Esterase |
| FIORNAL | Spinal and bulbar muscular atrophy (SBMA) |
| FISH | Spontaneous Abortion Chromosome Analysis |
| FK506 | Sputum Culture |
| FK-506 | SRY/AZF Determination |
| FLECAINIDE | ssay sensitivity) |
| FLOW ANTIBODY SCREEN | St Louis Encephalitis Virus Antibodies, IgG |
| FLU A | Stable Factor |
| FMR-1 Gene Trinucleotide Repeat Analysis | Sterile Body Fluid Culture |
| FOLATE | sTfR |
| Fourth Complement Component | STH |
| FPL | Stimulation Test |
| Fractionated Amino Acids, 24-Hour Urine | Stool Culture |
| Free and Albumin-Bound Testosterone | STR Analysis |
| Friedreich Ataxia (FRDA) | STS |
| FROZEN PLASMA | Stuart Factor |
| Fructosamine | Styrene Exposure Profile |
| FS | Sudan Black B |
| FSH | Sugar, Quantitative, Urine |
| Ft Bragg Fever | Sulfate, Quantitative, 24-Hour Urine |
| FT4 | SuperQuantTM HCV |
| FTA-Ab | Surface Factor |
| FULL CROSS | Susceptibility Testing |
| Functional Protein C | Swamp Fever |
| G-1-PUT | Swineherd Disease |
| G6PD | Synovial Fluid, Mucin Clot Test |
| G-6-PD QUANTITATIVE | Syphilis Serology |
| GABAPENTIN | Systemic Lupus Erythematosus (SLE) Profile A |
| GAD AUTOANTIBODIES | T-and B-Cell Gene Rearrangements |
| GALACTOSE | T Cell Receptor Beta Chain (TCRβ) |
| GAMMA GLUTAMYL TRANSFERASE | T3 |
| GANGLIOSIDE GM1 ANTIBODIES | T3, Free |
| Garamycin ® | T4 |
| Gastric Analysis | T4, Free by Equilibrium Dialysis, Serum |
| Gaucher Disease, DNA Analysis | T4/T8 Analysis |
| GC (Neisseria gonorrhoeae) Culture Only | TAC Antigen |
| GENERAL VIRAL CULTURE | Tambocor ® |
| Germ Cell Panel | Tape Test |
| Gestational Diabetes Evaluation | Tartrate-Resistant Acid Phosphatase Stain |
| GGT | Tay-Sachs Disease, Biochemical, Leukocytes |
| GHB | TB Stat Test |
| GIARDIA FA | TBG |
| GIEMSA STAIN | TBiIi |
| Glass Activation Factor | TCA, Urine |
| Gliadin Antibodies | T-CeIl Activation Profile, CD8 Subsets |
| Globulins, 24-Hour Urine | TCK |
| Glu | TCO2 |
| GLYCATED ALBUMIN | TeBG |
| GM1 ANTIBODIES | Tegretol ® |
| GM2 Gangliosidosis | Teichoic Acid Antibodies |
| GMS/FUNGAL SILVER STAIN | Tempra ® |
| Gonorrhea Culture | Testicular Cancer Monitor Profile |
| Goodpasture Syndrome | Tetanus Antibodies |
| GOT | Thallium, Urine |
| GPT | THC |
| GRAM SMEAR, DIRECT | Theo-Dur ® |
| Gross and Microscopic Pathology | Thiamine, Plasma |
| GT | Thorazine ® |
| GTT | Throat Culture |
| Gynecologic Pap Smear and Maturation Index | Thyrocalcitonin |
| H and E Sections | TIBC |
| H. FLU GROUP B LATEX AGGLUTINATION | Tissue Karyotype |
| H. PYLORI AB | Titratable Acidity |
| H2 RECEPTOR ANTAGONIST | TI, Urine |
| H2a/H2b and H3 and H4 Antibodies | TLI |
| HAA | T-Lymphocyte Helper/Suppressor Profile |
| Haemophilus influenzae B Antigen | TNF |
| Hageman Factor | Tobramycin (Nebcin ®), Serum, Peak |
| Hairy Cell/Plasma Cell Leukemia Profile | Tofranil ® |
| Haldol ® | Toluene Exposure Profile |
| HAMA | Topiramate (Topamax ®), Serum |
| HANE Assay | Total Bili |
| Haptoglobin | Toxoplasma gondii Antibodies, IgG |
| HAV/HBV (Profile VII) | TPO Antibodies |
| Hb A1c | TProt |
| HBcAb, IgG/IgM Diff | TRAb |
| HBeAb | Treponema pallidum Antibodies (FTA-ABS) |
| HBSAB | Triavil ® |
| HBV DNA Qualitative PCR | t-RNA Synthetase |
| HCG | Troponin I |
| HCT | True Cholinesterase |
| HCV Ab (Immunoblot Reflex) | Trypsin |
| HDL | TSH Receptor Ab |
| HDV | TSI |
| Heat Precipitate Fibrinogen | Tularemia Agglutinins |
| HEINZ BODY STAIN | Tumor Necrosis Factor- |
| Helicobacter pylori Antibodies | Twin Zygosity, Pre- and Postnatal |
| Hema-Chek ® | Tylenol ® |
| HEP AM | Type and Rh |
| HER-2/neu Gene Amplification | Tyrosine Phosphatase Autoantibodies |
| Heterophil Agglutinins | Tzanck Smear |
| Hexagonal Phase Phospholipid | UA |
| Hg, Blood | UA, Routine |
| HGB | UIBC |
| HGF | UltraQualTM HCV |
| HGH | Unbound T3 |
| HHV-6, IgG | Unconjugated DHEA |
| High Resolution G-Banding | Undifferentiated Tumor Panel |
| HIPA | Uniparental Disomy Profile |
| Hirsutism Prof, Comprehensive | Unsaturated Iron Binding Capacity |
| HISTAMINE | Upper Respiratory Culture, Routine |
| HITS | Urea Clearance |
| HIV | Uric A |
| HLA A Typing | Uroporphyrin |
| HNPCC, Direct, Known Mutation | Uterine Cancer Monitor Profile |
| Hog | UUN Clearance |
| HOLD SPECIMEN | Vaginal Cytology |
| Homocyst(e)ine, Plasma or Serum | Valium ® |
| Hormonal Evaluation Cytology | Vancocin ® |
| HPV | Varicella-Zoster Virus (VZV) Antibodies, IgG |
| HS CRP | Vasoactive Intestinal Polypeptide (VIP), Plasma |
| HSF | VDRL, Cerebrospinal Fluid |
| HSV | VGCC Antibody |
| HTLV | VIP |
| Human Antimouse Antibodies | Viral Culture, General |
| HUNTINGTON DISEASE MUTATION | Viscosity, Serum |
| HVA | Vitamin A and Carotene |
| Hybrid Capture | VMA and Catecholamines |
| Hyperhomocysteinemia, C677T Mutation | Volatiles, Blood |
| IA2 Antibodies | von Recklinghausen Disease |
| IA-9 | VRE, Culture Only |
| IAA | vW Factor Assay |
| IBC | vWF Antigen |
| IBUPROFEN | VZV by DFA |
| ICA512 Autoantibodies | Warfarin (Coumadin ®), Serum |
| ICSH | WBC |
| Ictotest ® | WBlot HIV1 |
| Identification of Atypical Bacteria | Weil Disease |
| IFE/Protein Electro, 24-Hr Ur | Westergren Sedimentation Rate |
| Ig Heavy Chain Gene Rearrangement | Wet Prep |
| IGA | White Blood Cell (WBC) Count |
| IgD | Whole Blood Histamine |
| IgE | Wood Alcohol |
| IGF BINDING PROTEIN 3 | Wound |
| IGG | Wright-Giemsa Stain |
| IGM | Wuchereria Smear |
| IL-2 sR | Xylenes Exposure Profile |
| Imavate ® | Yeast Culture |
| IMIPRAMINE | Zarontin ® |
| IMMEDIATE SPIN CROSSMATCH | Zinc, Plasma/Serum |
| In situ Hybridization for HPV | Zn, Serum |
| Inborn Errors of Metabolism | ZPP |
| Inclusion Body Stain | ZYGOSITY TESTING |
| INDIA INK (SpinalFl) | |
| INFECTIOUS MONO | |
| Inherited Mental Retardation | |
| Inorganic Phosphate, Blood | |
| INR | |
| Insulin | |
| lnterleukin-2 Receptor | |
| IONIZED CALCIUM | |
| IRON | |
| IS CROSSMATCH | |
| ISLET CELL ANTIBODY | |
| Isoagglutinins | |
| ITRACONAZOLE LEVEL | |
| IVY BLEEDING TIME | |
| Ixodes Tick Bite Agent | |
| Jembec Culture | |
| Jewish Heritage | |
| JO 1 | |
| JOINT FLUID | |
| JUMBO FFP | |
| K | |
| K and L Chains, Urine | |
| Kappa Light Chains, Urine | |
| Karyotype | |
| KENNEDY DISEASE DNA | |

We claim:

1. A method for identifying a research subject, comprising:
obtaining medical data from a subject;
associating an identifier for said subject with said medical data in at least a first database;
associating the identifier for said subject with the name and contact information of said subject;
identifying criteria for selecting a research subject;
extracting an identifier from the first database, wherein said identifier is associated with a subject matching the identified criteria; and
matching the identifier from the first database with the name and contact information in order to identify the research subject.

2. The method according to claim 1, further comprising obtaining informed consent from said subject, wherein said informed consent permits the medical data to be used to identify said subject as a potential research subject.

3. The method according to claim 1, wherein medical data are obtained from said subject and associated with the identifier for said subject in at least a first database longitudinally.

4. The method according to claim 1, wherein said subject is a member of a group of donors, and said method is repeated for each member.

5. The method according to claim 1, wherein the subject is a deferred donor.

6. The method according to claim 1, wherein the medical data comprise a medical history.

7. The method according to claim 1, wherein the medical data comprise a family history.

8. The method according to claim 1, wherein the medical data comprise clinical chemistry test results.

9. The method according to claim 1, wherein the medical data comprise pharmacogenomic or genomic data.

10. The method according to claim 1, wherein the medical data comprise proteomic data.

11 The method according to claim 1, wherein the criteria include medical history information.

12. The method according to claim 1, wherein the criteria include family history information.

13. The method according to claim 1, wherein the criteria include clinical chemistry test results.

14. The method according to claim 1, wherein the criteria include pharmacogenomic or genomic information.

15. The method according to claim 1, wherein the criteria include proteomic information.

16. The method according to claim 1, wherein said first database is a computerized database.

17. The method according to claim 1, wherein the name and contact information is stored in at least a second database.

18. The method according to claim 17, wherein said first database and said second database are computerized databases.

19. The method according to claim 18, wherein the first and second databases are stored on separate computers.

20. The method according to claim 19, wherein the computer storing the first database is connected through a network firewall with the computer storing the second database.

21. The method according to 1, wherein the first database is a computerized database and is accessible through a network.

22. The method according to claim 21, wherein the network is a local area network or an intranet.

23. The method according to claim 21, wherein the network is an internet.

24. A method for identifying a research subject in a group of donors from at least one collection establishment, comprising:
a. obtaining a biological sample and medical data from a donor;
b. associating an identifier for said donor with said biological sample and medical data in at least a first database;
c. associating the identifier for said blood donor with the name and contact information of said donor;
d. identifying criteria for selecting a research subject;
e. extracting an identifier from the first database, wherein said identifier is associated with a donor matching the identified criteria; and
f. matching the identifier from the first database with the name and contact information in order to identify a research subject.

25. The method according to claim 24, further comprising obtaining informed consent from said blood donor, wherein said informed consent permits the medical data to be used to identify said blood donor as a potential research subject.

26. The method according to claim 24, wherein medical data are obtained from said donor and associated with the identifier for said donor in at least a first database longitudinally.

27. The method according to claim 24, wherein said donor is a deferred donor.

28. The method according to claim 24, wherein the medical data comprise a medical history.

29. The method according to claim 24, wherein the medical data comprise a family history.

30. The method according to claim 24, wherein the medical data comprise clinical chemistry test results.

31. The method according to claim 24, wherein the medical data comprise pharmacogenomic or genomic data.

32. The method according to claim 24, wherein the medical data comprise proteomic data.

33. The method according to claim 24, wherein the criteria include medical history information.

34. The method according to claim 24, wherein the criteria include family history information.

35. The method according to claim 24, wherein the criteria include clinical test results.

36. The method according to claim 24, wherein the criteria include pharmacogenomic or genomic information.

37. The method according to claim 24, wherein the criteria include proteomic information.

38. The method according to claim 24, wherein said first database is a computerized database.

39. The method according to claim 24, wherein the name and contact information of said blood donor is stored in at least a second database.

40. The method according to claim 39, wherein said first database and said second database are computerized databases.

41. The method according to claim 40, wherein said first and second databases are stored on separate computers.

42. The method according to claim 41, wherein the computer storing the first database is connected through a network firewall with the computer storing the second database.

43. The method according to 24, wherein the first database is a computerized database and is accessible through a network.

44. The method according to claim 43, wherein the network is a local area network or an intranet.

45. The method according to claim 43, wherein the network is an internet.

46. A plurality of biological samples collected from at least one subject, wherein each sample is associated with an identifier linking said biological sample to at least one of medical data, genomic data, pharmacogenomic data, and proteomic data in at least a first database and wherein said biological samples are collected and stored longitudinally.

47. The plurality of biological samples according to claim 46, wherein said samples are whole blood, plasma, serum, blood cells, and proteins or nucleic acids isolated therefrom.

48. A plurality of biological samples collected from at least one donor, wherein each sample is collected at a collection establishment and associated with an identifier linking said donor and said biological sample to at least one of medical data, genomic data, pharmacogenomic data, and proteomic data in at least a first database and wherein said plurality of biological samples are collected and stored longitudinally.

49. A method for creating a database, the method comprising:
a. collecting a biological sample from at least one subject;
b. collecting a medical data from said at least one subject;
c. deriving proteomic information and genomic information from the sample;
d. storing the sample in a location from which the sample can be recovered;
e. associating the medical data, the proteomic information, and the genomic information with an identifier that can be used to locate the sample; and
f. performing steps a to e on the same subject longitudinally; and wherein steps b to d may be performed in any order.

50. The method according to claim 49, wherein steps a to f are performed on multiple subjects.

51. The method according to claim 49, wherein the biological sample is whole blood, plasma, serum, blood cells, or proteins or nucleic acids isolated therefrom.

52. The method according to claim 49, wherein the samples are collected from at least one collection establishment.

53. The method according to claim 49, wherein said medical data comprises clinical chemistry test information.

54. The method according to claim 53, wherein the clinical chemistry test is at least one test selected from ABO/RH type, antibody screening tests, alanine aminotransferase (ALT) tests, cytomegalovirus (CMV) screening, hepatitis B screening, hepatitis B core antibody screening, hepatitis C screening, human immunodeficiency virus (HIV) types 1 and 2 screening, human T-cell lymphotropic virus (HTLV)-1 screening, and HIV antigen screening.

55. The method according to claim 49, wherein the genomic information includes DNA polymorphisms.

56. The method according to claim 49, wherein the DNA polymorphisms are single nucleotide polymorphisms.

57. The method according to claim 49, wherein the proteomic information includes the proteins expressed in the sample.

58. The method according to claim 49, wherein the genomic information includes the ribonucleic acids expressed in the sample.

59. The method according to claim 49, wherein said medical data comprises family histories from the subjects.

60. The method according to claim 49, wherein said medical data comprises demographic information from the subjects.

61. The method according to claim 49, wherein at least one of the medical data, the genomic information, the proteomic information, and the location for the sample is associated with an identifier for the subject that can be used to retrieve the name and contact information of said subject

62. A method for identifying a genomic or a proteomic characteristic which correlates with a disease, said method comprising:
creating a database according to claim 48;
identifying subjects with the disease;
identifying genomic and proteomic characteristics shared by said subjects.

63. The method according to claim 62, wherein the genomic characteristic identified is a single nucleotide polymorphism.

64. The method according to claim 62, wherein the genomic characteristic identified is pharmacogenomic information.

65. The method according to claim 62, wherein the proteomic information is a change in protein level.

66. A method for recruiting a research subject for a clinical study, said method comprising:
identifying said research subject according to claim 1 according to selected criteria; and
contacting said research subject for recruiting said research subject for said clinical study.

67. A method for recruiting a research subject for a clinical study, said method comprising:
identifying said research subject according to claim 24 according to selected criteria; and
contacting said research subject for recruiting said research subject for said clinical study.

68. The method according to claim 27, wherein said deferred donor is a deferred blood or plasma donor.
